(19) United States
(12) Patent Application Publication
(10) Pub. No.: US 2004/0112708 A1
(43) Pub. Date: Jun. 17, 2004

(54) Triggering arrangement for a friction clutch

(75) Inventors: Horst Friedrich, Aidhausen (DE); Arnold Huisjes, Schweinfurt (DE); Werner Selzam, Wipfeld (DE); Jorg Pankoke, Leonberg (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/668,769

(22) Filed: Sep. 22, 2003

(30) Foreign Application Priority Data
Sep. 21, 2002 (DE) 102 43 991.5

(51) Int. Cl. F16D 11/00

(52) U.S. Cl. 192/112

(57) ABSTRACT

A triggering arrangement for a friction clutch includes at least one triggering element arrangeable on a clutch housing and is designed to interact with a pick-up arrangement to generate information relating to the rotary movement of the clutch housing about an axis of rotation. The at least one triggering element is of separate design from the clutch housing and is permanently connected or connectable thereto.

### BACKGROUND OF THE INVENTION

1. Field of the Invention

The present invention relates to a triggering arrangement for a friction clutch including at least one triggering element on a clutch housing which interacts with a pick-up arrangement to generate information relating to the rotary movement of the clutch housing.

2. Description of the Related Art

In motor vehicles, information which relates to the rotational speed of the drive assembly or, if appropriate, also to the rotary position of a crankshaft of the drive assembly, is required to actuate various system components. For this reason, magnetically effective pick-ups which sense triggering information on a clutch housing are generally used. The clutch housings are generally made as steel components, as are flywheels or the like. Projection formations which interact with a magnetic pick-up may be formed integrally on these housings or flywheels. In the field of motor car racing, and also increasingly in conventionally used motor vehicles, the use of the lightest components possible is desired. To achieve the lightest weight possible, components made of non-magnetic or non-magnetizable material are also used in the clutch area. However, even when such components are made of basically magnetizable material such as, for example, steel, the integral formation of the triggering arrangement may have a detrimental effect on other areas of these components or the triggering arrangement may be formed only with limited precision, for example by carrying out a shaping procedure of a sheet metal material.

### SUMMARY OF THE INVENTION

The object of the present invention is to provide a triggering arrangement for a friction clutch which, while having a simple design which is suitable for precise sensing, can be used essentially independently of the design of other clutch components.

According to the invention, this object is achieved by a triggering arrangement for a friction clutch, comprising at least one triggering element arranged on a clutch housing and which can interact with a pick-up arrangement to generate information relating to the rotary movement of the clutch housing about an axis of rotation. The triggering element is designed separate from the clutch housing and is permanently connected, or permanently connectable, thereto.

As a result of the separate construction of the at least one triggering element, it can be manufactured from a suitable material independently of the material used to construct the clutch housing. In addition, the triggering element may also be manufactured independently of the manufacturing process of the clutch housing, especially also essentially independently of its shaping.

In the present invention, a plurality of triggering elements may be provided following one another in the circumferential direction about the axis of rotation. Here, an embodiment which is structurally very easy to implement may be provided by forming the triggering elements on a triggering ring which is connected, or is connectable, to the clutch housing. However, to minimize weight, it may be advantageous if the triggering elements are connected, or connectable, individually or in triggering element groups to the clutch housing. At least some ring sections which connect individual triggering elements are thus dispensed with.

In order to be able to support the triggering elements suitably against the effect of centrifugal forces, especially when there is a separate or grouped configuration of the triggering elements, the triggering elements or triggering element groups may have an engagement projection that is engageable in a radially positively locking fashion with an assigned mating engagement projection on the clutch housing. In this way, an increased positional accuracy in the region of the triggering elements is simultaneously also ensured.

The triggering elements may be connected, or be connectable, to the clutch housing by screwing or riveting.

The housing may be constructed from non-magnetizable material such as, for example, titanium to minimize the weight of the housing. The triggering elements can especially be formed from magnetizable material such as, for example, steel or the like, especially to interact with a magnetically effective pick-up.

The present invention also relates to a friction clutch with a triggering arrangement according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective view of a clutch housing with a plurality of separately formed triggering elements according to the present invention;

FIG. 2 is a partial longitudinal sectional view of the arrangement shown in FIG. 1 in the region of the connection of the clutch housing to a triggering element;

FIG. 3 is a perspective view of an alternative embodiment of a clutch housing according to the invention.

### DETAILED DESCRIPTION OF THE PREFERRED EMBODIMENTS

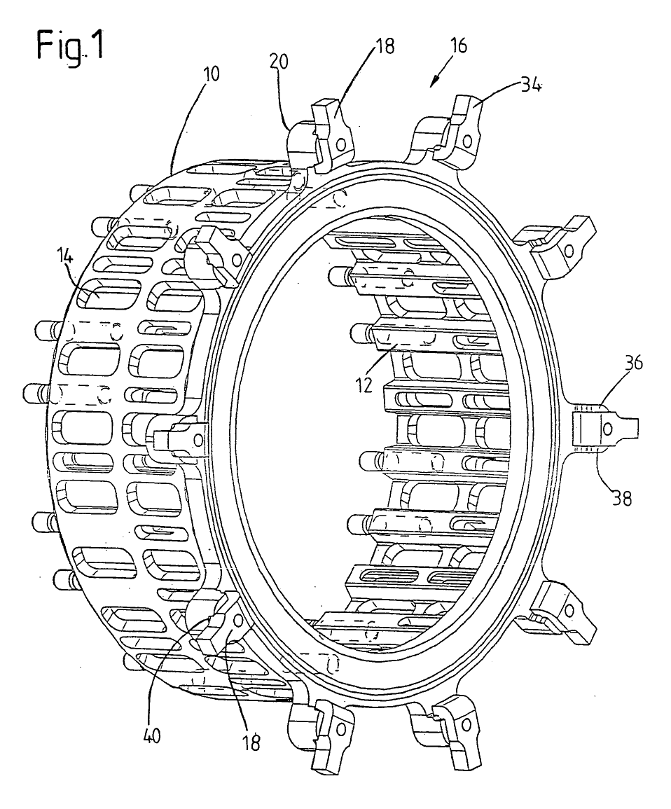

In FIG. 1, a housing 10 of a friction clutch of essentially ring-shaped construction is shown having at a plurality of circumferential positions, radially inwardly protruding projections 12 which engage in corresponding cutouts on lamellas of a friction clutch which surrounds the housing. In this way, a plurality of disks may be coupled to the housing 10 for the sake of common rotation therewith, and simultaneously be moveable to a limited degree in the direction of an axis of rotation with respect to the housing 10. Such wet multi-disk clutched are used, for example, in the field of motor racing and have the significant advantage that they make available a very large surface which becomes frictionally effective overall in a comparatively small constructional space. To save weight, a plurality of cutouts 14 are provided in the housing 10. Furthermore, the housing 10 may be fabricated from very lightweight material such as, for example, titanium which at the same time has sufficient rigidity.

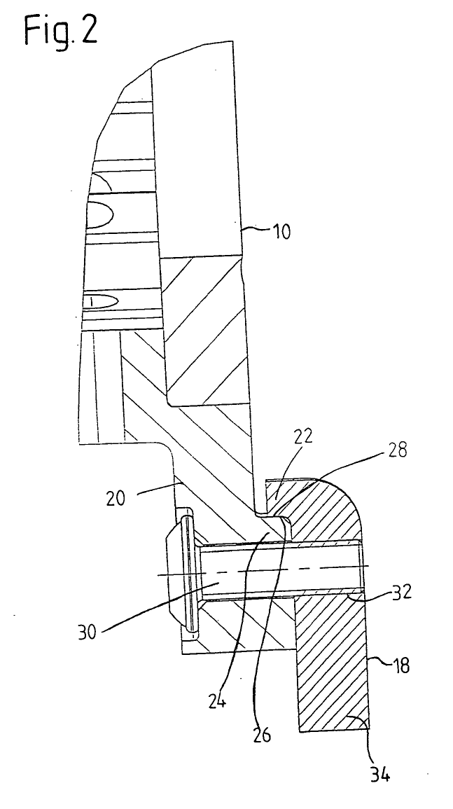

A triggering arrangement 16 is provided on the housing 10 to obtain information about the rotary movement of the housing 10, in particular the rotational speed of a drive assembly which is permanently connected to the housing 10. This comprises, in the example shown in FIGS. 1 and 2, a plurality of triggering elements 18 which are arranged in succession in the circumferential direction around an axis of rotation. In an assignment to each triggering element 18, a coupling area 20 is provided protruding radially outward on the housing 10. As is apparent from the sectional illustration in FIG. 2, the triggering elements 18 are constructed at their radially inner end area with an essentially axially extending engagement projection 22. The coupling areas 20 each have a mating engagement projection 24 which is assigned to these engagement projections 22. The engagement projection 22 and the mating engagement projection 24 bear against one another with surfaces 26, 28 which lie essentially radially opposite one another. Firstly, this type of clutch which acts in a frictionally locking fashion in the radial direction provides support for the triggering elements 18 in the radial direction. On the other hand, the two surfaces 26, 28 which bear against one another bring about very precise positioning of the triggering elements 18.

In order to couple the triggering elements 18 in a permanent fashion to the housing 10, screw bolts 30 are passed through the coupling areas 20 and engage in internally threaded openings 32 of the triggering elements 18. Here, for example a riveted connection could also be provided instead of the screwed connection.

In one preferred embodiment, the triggering elements 18 are made of magnetizable material, i.e., steel material, and generate a pulse when they move past a suitably positioned pick-up. The chronological sequence of the pulses enables the rotational speed to be determined. Furthermore, given suitable shaping of at least one of the triggering elements 18, it is possible to determine the rotary position, by virtue of the fact that a pulse with a different shape occurs periodically. It should be noted that of course other pulse generators may also be used. For example, the triggering elements 18 could also be sensed visually to generate a corresponding signal by periodic reflection or periodic coverage of an optical pick-up.

The triggering elements 18 can extend comparatively far in the radially outward direction with their triggering sections 24 which are provided for interaction with a pick-up, and can extend essentially independently of the specific shape of the housing 10 per se. This provides a relatively large degree of freedom in the the positioning of the pick-ups which interact with the triggering elements 18.

Since the triggering elements 18 of the triggering arrangement 16 are constructed separately from the housing 10, not only is there a greater degree of freedom in the selection of the materials to be respectively used, so that the housing on the one hand and the triggering elements on the other can be constructed from materials which are respectively optimized for the specific requirements, but also there is a much smaller degree of restriction in the fabrication, especially of the housing 10, by virtue of the fact that a specially shaped triggering arrangement has to be made available. It should be noted here that the triggering elements 18 do not necessarily have to protrude radially beyond the housing 10. For example, when a pick-up is positioned in an axial sequence on the housing 10, the triggering elements 18, which are constructed, for example, from magnetizable steel material, form areas on a housing 10 which is then made of non-magnetizable material, which areas move past the pick-up periodically and can cause a signal which represents the rotational speed and if appropriate also the rotary position to be generated. To this extent, the coupling areas 20 which can be seen in FIG. 1 do not necessarily need to be constructed as radially outwardly protruding coupling areas. Instead, they could also be constructed in axial alignment with the essentially ring-shaped housing.

In order to obtain the high precision for the rotational speed or position sensing especially in the circumferential direction, circumferential supports 36, 38, which form a cutout 40 between them to essentially accommodate a respective triggering element 18 free of play, are constructed on the coupling areas 20 on each side of a respective triggering element 18. Very precise positioning of the triggering elements on the housing 10 is thus ensured not only in the radial direction but also in the circumferential direction.

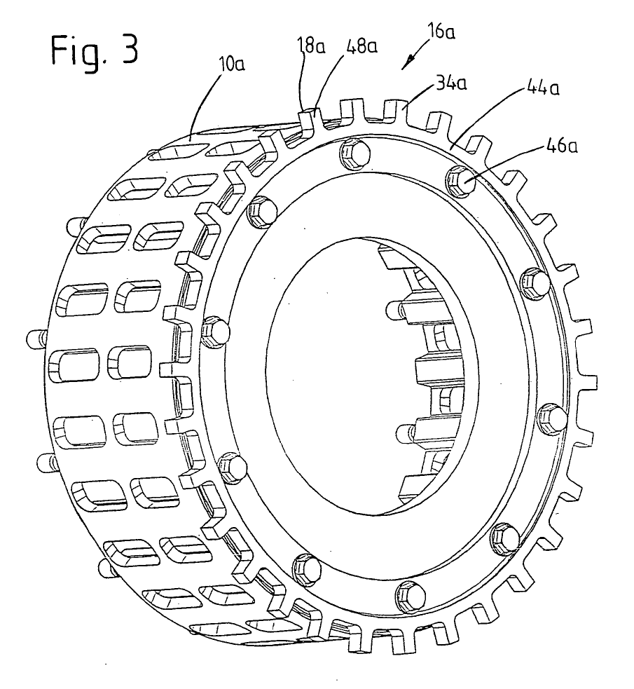

FIG. 3 shows an alternative embodiment in which components which correspond in design and function to the components described above are designated by the same reference symbol with the addition of an appended “a”.

The triggering arrangement 16a comprises here a triggering ring 44a which may be secured to an end wall of the housing 10a by a plurality of screw bolts 46a or rivet bolts or the like and which is fitted on its outer circumferential area, if appropriate also on an end side, with projections 48a which protrude radially outward, and if appropriate then in the axial direction, and which form the triggering elements 18a. That is, the plurality of triggering elements which follow one another in the circumferential direction are provided on a ring-shaped component, which on the one hand increases the positional precision of the triggering elements 18a with respect to one another and on the other hand at the same time also ensures a stable radial support of said elements. It should be noted that, of course, triggering elements may also be combined to form groups and then secured to the housing in groups, that is to say in a continuous annular contour. Even in the embodiment variant shown in FIG. 3, the triggering elements 18a, and their triggering sections 34a which are effective to interact with a pick-up, do not necessarily need to protrude radially outward beyond the housing 10a. As already stated, an arrangement of triggering elements 18a which protrudes axially could also be made available.

It should furthermore be noted that, depending on the configuration of the housing, the triggering elements or the triggering elements provided on a ring or ring section can be provided on the side of the housing which is to be positioned facing the engine or on the side of the housing which is to be positioned facing the gearbox. For example, it is also possible for the triggering ring described above or the triggering elements described above to be constructed or provided on a housing cover which, for example, closes off the housing shown in FIG. 1 and on which, for example, a power accumulator is supported. For example, the triggering ring 44a which can be seen in FIG. 3 may be used in place of a housing cover. That is, the release ring 44a may comprise a housing component. With a housing cover, which is positioned near the gearbox, this results in the advantage that the triggering elements, and with them also the corresponding sensors, may be positioned further away from the engine. However, even with such a configuration, it is basically possible to install such a clutch in a drive train in such a way that the housing cover, together with the triggering elements provided on it, is positioned near the engine. Basically, for example even in the embodiment according to FIG. 1, the coupling areas which support the individual triggering elements could also be positioned in an area of the housing which lies more centrally—viewed in the axial direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A triggering arrangement for a friction clutch, comprising a clutch housing rotatable about an axis of rotation and at least one triggering element connected to said clutch housing and interactable with a pick-up arrangement for generating information relating to the rotary movement of said clutch housing about an axis of rotation, said at least one triggering element being of separate design from said clutch housing.

2. The triggering arrangement of claim 1, wherein a plurality of triggering elements are arranged in circumferential succession on said clutch housing about the axis of rotation.

3. The triggering arrangement of claim 2, further comprising a triggering ring connected to said clutch housing, wherein said triggering elements are formed on said triggering ring.

4. The triggering arrangement of claim 2, wherein the triggering elements are connected individually or in triggering element groups to said clutch housing.

5. The triggering arrangement of claim 4, wherein the triggering elements or triggering element groups have an engagement projection which engages an assigned mating engagement projection on said clutch housing by a radially positive locking connection.

6. The triggering arrangement of claim 1, wherein said at least one triggering element is connected to said clutch housing by a screw or rivet connection.

7. The triggering arrangement of claim 1, wherein said clutch housing is formed from non-magnetizable material and wherein said at least one triggering element is formed from magnetizable material.

8. The triggering arrangement of claim 1, wherein said clutch housing is formed from titanium and wherein said at least one triggering element is formed from steel.

9. A friction clutch comprising a clutch housing rotatable about an axis of rotation and a triggering arrangement having at least one triggering element connected to said clutch housing and interactable with a pick-up arrangement for generating information relating to the rotary movement of said clutch housing about an axis of rotation, said at least one triggering element being of separate design from said clutch housing.

10. A triggering arrangement for a friction clutch with a clutch housing rotatable about an axis of rotation, the triggering arrangement comprising at least one triggering element connectable to the clutch housing and interactable with a pick-up arrangement for generating information relating to the rotary movement of the clutch housing about the axis of rotation, said at least one triggering element being a separate element from the clutch housing.

11. The triggering arrangement of claim 10, wherein said at least one triggering element comprises a plurality of triggering elements arrangeable in circumferential succession on the clutch housing about the axis of rotation.

12. The triggering arrangement of claim 11, further comprising a triggering ring connectable to the clutch housing, wherein said triggering elements are formed on said triggering ring.

13. The triggering arrangement of claim 11, wherein said triggering elements are connectable individually or in triggering element groups to the clutch housing.

14. The triggering arrangement of claim 13, wherein said triggering elements or triggering element groups have an engagement projection engageable in a radially positively locking fashion with an assigned mating engagement projection on the clutch housing.

15. The triggering arrangement of claim 10, wherein said at least one triggering element is connectable to the clutch housing by a screw or rivet connection.
